(19) United States
(12) Patent Application Publication
(10) Pub. No.: US 2014/0013409 A1
(43) Pub. Date: Jan. 9, 2014

(54) SINGLE SIGN ON FOR CLOUD

(71) Applicant: Milind I. Halageri, Karnatokg (IN)

(72) Inventor: Milind I. Halageri, Karnatokg (IN)

(21) Appl. No.: 13/542,953

(22) Filed: Jul. 6, 2012

(51) Int. Cl. H04L 29/06

(52) U.S. Cl. CPC H04L 63/0815
USPC 726/8

(57) ABSTRACT

Systems and methods for single sign on to a cloud. The system includes a cloud service provider and a tenant. The cloud service provider has a consumer unit and a portal. The consumer unit provides an interface for a user to connect to the cloud service provider. The portal providing a cloud service to the user, the portal has a first authentication system that issues a security token request and that is connected to the consumer unit. The tenant includes the user and a second authentication system. The second authentication system signs the security token request. The consumer unit is adapted to communicate with the first authentication system using a first protocol and adapted to communicate with the second authentication system using a second protocol.

### TECHNICAL FIELD

The present invention relates generally to a system for management of information technology systems.

### BACKGROUND

Cloud computing enables convenient, on-demand network access to a shared pool of configurable computing resources, for example, networks, servers, storage, applications, and services that can be rapidly provisioned and released with minimal management effort or service provider interaction. For one or more end-users that are attached to the shared pool of configurable computing resources that comprise a cloud, cloud computing provides computation, applications, data access, and storage services for the end-user. The end-user does not require knowledge of the physical location and configuration of the system that delivers the services. Further, the end-user is able to pay for the computation, applications, data access, and storage services based on the amount of usage rather than having to purchase and manage dedicated computation, applications, data access, and storage resources.

Clouds are developed as stand-alone platforms and include hardware and applications necessary to perform required services for the end-users. In some contexts, clouds are known as platforms. The term “cloud” for the purpose of this application also encompasses the term “platform.” The term “off-site cloud” is used to refer to a public cloud, which is a cloud that is accessible on the Internet. The term “in-house cloud” is used to refer to a private cloud, which is not generally accessible on the Internet.

Examples of the services include software as a service (“SAAS”), platform as a service (“PAAS”), and infrastructure as a service (“IAAS”). In SAAS, users pay a fee on a recurring basis to access and use specific applications. In PAAS, the user leases access to an entire platform, for example, a customer resource management platform. In IAAS, the user leases access to certain infrastructure, for example, a physical or virtual server with particular computational and/or storage capabilities.

In recent times, as IT systems proliferate to support business processes, users and system administrators are faced with an increasingly complicated interface to accomplish their job functions. Users typically have to sign-on to multiple systems, necessitating an equivalent number of sign-on dialogues, each of which may involve different usernames and authentication information. System administrators are faced with managing user accounts within each of the multiple systems to be accessed in a coordinated manner in order to maintain the integrity of security policy enforcement.

Clouds employ virtualization to perform tasks. The virtualization creates virtual machines running on the hardware, the virtual machines running applications. Each virtual machine has security features of some kind to give some users access to portions of the virtual machine but deny access to other users. Further, each application running on a virtual machine has additional security to give some users access to portions of the application but deny access to other users. Some systems may have thousands of virtual machines, applications, and users. Further, one user may require access to thousands of virtual machines. This can make standard authentication impractical because of the large number of devices that users have to authenticate with. Further, differing operating systems and domains used by the user, the cloud infrastructure, and the virtual machines in the cloud, complicate the authorization and authentication process.

In one conventional configuration, tenants subscribe to services provided by a cloud provider. The tenants can be other organizations with their own identity management system. The tenants may want the cloud provider to use their own existing identity management system to authenticate their users instead of registering each of the tenant's users in the cloud provider's identity management system.

### SUMMARY

The systems and methods described herein attempt to overcome the drawbacks discussed above.

In one embodiment, a system for single sign on to a cloud comprises a cloud service provider and a tenant. The cloud service provider comprises a consumer unit and a portal. The consumer unit provides an interface for a user to connect to the cloud service provider. The portal provides a cloud service to the user, the portal comprising a first authentication system that issues a security token request and that is connected to the consumer unit. The tenant comprises the user and a second authentication system. The second authentication system signs the security token request. The consumer unit is adapted to communicate with the first authentication system using a first protocol and adapted to communicate with the second authentication system using a second protocol.

In another embodiment, a system for single sign on to a cloud comprises a cloud service provider and a tenant. The cloud service provider comprises a consumer unit, a portal, and a first authentication system. The consumer unit provides an interface for a user to connect to the cloud service provider. The portal provides a cloud service to the user, the portal comprising a second authentication system connected to the consumer unit. The first authentication system connected to the consumer unit. The tenant comprises the user and a third authentication. The third authentication system connected to the user. The consumer unit is adapted to communicate with the first authentication system using a first protocol and adapted to communicate with the second authentication system using a second protocol. The first authentication system is federated with the third authentication system.

In yet another embodiment, a method for single sign on to a cloud system is disclosed. A consumer unit of a cloud provider receiving a request from a user for a cloud service. The consumer unit requesting a portal to provide access to the cloud service based on the request from the user. A first authentication system of the portal requesting a security token from the consumer unit using a first protocol, the request by the first authentication system based on the request by the consumer unit. The consumer unit translating the security token request from the first protocol to a second protocol. The consumer unit requesting a second authentication system to sign the requested security token using the second protocol. The consumer unit receiving the signed security token. The consumer unit translating the signed security token from the second protocol to the first protocol. The consumer unit sending the signed security token to the portal using the first protocol. The portal, providing the cloud service to the user based on the signed security token.

In still yet another embodiment, a machine-readable tangible and non-transitory medium with information recorded thereon, wherein the information, when read by a machine, causes the machine to perform the following steps. A consumer unit of a cloud provider receiving a request from a user for a cloud service. The consumer unit requesting a portal to provide access to the cloud service based on the request from the user. A first authentication system of the portal, requesting a security token from the consumer unit using a first protocol. The request by the authentication system based on the request from the consumer unit. The consumer unit, translating the security token request from the first protocol to a second protocol. The consumer unit requesting a second authentication system to sign the requested security token using the second protocol. The consumer unit translating the signed security token from the second protocol to the first protocol. The consumer unit sending the signed security token to the portal using the first protocol. The portal providing the cloud service to the user based on the signed security token.

### BRIEF DESCRIPTION OF THE DRAWINGS

The accompanying drawings constitute a part of this specification and illustrate an embodiment of the invention, and together with the specification, explain the invention.

FIG. 1 illustrates a cloud system according to an embodiment.

FIG. 2 illustrates another cloud system according to an embodiment.

FIG. 3 illustrates yet another cloud system according to an embodiment.

FIG. 4A-B illustrate how WS-Trust and WS-Policy are used along with different WS-* specifications implemented in the areas of Security, Reliability, and Transactions, according to an exemplary embodiment.

FIG. 5 illustrates the programming model with WSIT according to an exemplary embodiment.

FIG. 6 illustrates a method for the cloud portion of single sign on to a cloud provider according to an exemplary embodiment.

FIG. 7 illustrates a method for the tenant portion of single sign on to a cloud provider according to an exemplary embodiment.

FIG. 8 illustrates a general computer architecture according to an exemplary embodiment.

### DETAILED DESCRIPTION

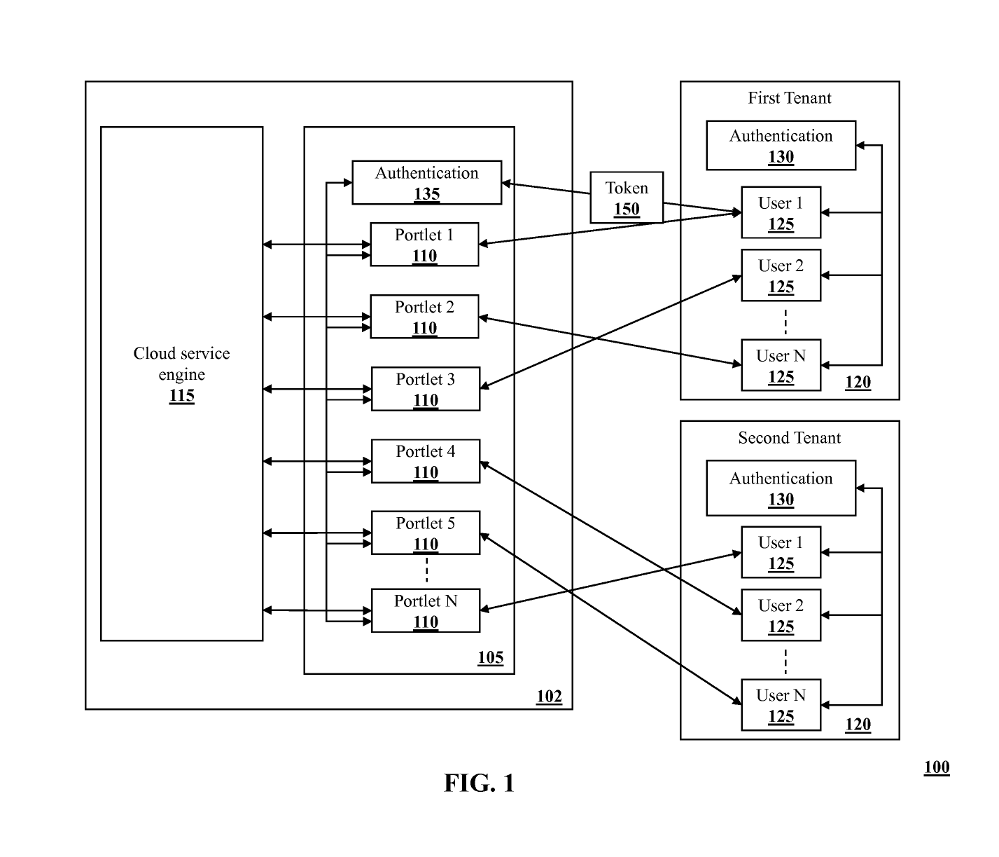

FIG. 1 illustrates a cloud system 100. The cloud system 100 comprises a cloud service provider 102 and first and second tenants 120 that subscribe to the cloud service. The cloud service provider 102 comprises a portal 105 that comprises one or more portlets 110, a cloud service engine 115 that provides cloud services, and an authentication system 135. The tenants comprise users 125 that use the cloud and an authentication system 130. The tenants 120 may be, for example, companies, or departments in a company, and the users may be the employees of the company. There may be any number of tenants connected to the cloud service provider 102. The cloud service provider 102 and the tenants 120 may be on the same network or intranet. Alternatively, the tenants 120 may be connected to the cloud service provider 102 via the Internet.

The authentication mechanisms of the tenant include, for example, Lightweight Directory Access Protocol (LDAP) and Active Directory Federation Services (ADFS). The first and second tenants 120 and the portal 105 may be on different domains, therefore, the tenant authentication methods cannot be used to authenticate a user in another tenant or at the portal 105.

To use the services provided by the tenant 120, including the services provided by the cloud service provider 102, a user 125 authenticates with the authentication system 130 of the tenant. To use a cloud service, a user 125 also authenticates with the authentication system 135 of the portal. In some embodiments, a separate authentication is further required for each portlet 110. Thus, the user 125 may provide numerous user names and passwords before using the cloud service.

In a federated authentication system a common set of policies, practices, and protocols are put in place to manage the identity and trust among users and devices across organizations and domains. Identity federation enables users of one domain to access securely data or systems of another domain seamlessly, and without the need for completely redundant user administration. This process is known as Single sign on. Federation is enabled using open industry standards and/or openly published specifications, such that multiple parties can achieve interoperability for common use cases. Typical use-cases involve things such as cross-domain; web-based single sign-on, cross-domain user account provisioning, cross-domain entitlement management, and cross-domain user attribute exchange. ADFS provides such federated services using claims based authentication.

In claims based authentication, a trusted authority (Issuer) issues a signed security token containing a set of claims (credentials) which is given to an application, for example the cloud service provider 102 for validation. The application will authenticate the user if the security token is valid and signed by a trusted issuer, for example, authentication system 130 of the tenant 120. Claims-based identity simplifies application development because applications using this type of authentication do not have to verify all the credentials presented by the user. Instead letting the issuer to deal with all security issues involved eases the process of integration, migration, merger, federation, or building cloud applications.

Single sign on has many benefits. Single sign on reduces the time taken by users in sign-on operations to individual domains and reduces the possibility of such sign on operations failing. Single sign on improves security through the reduced need for a user to handle and remember multiple sets of authentication information. Single sign on reduces the time taken, and improves the response, by system administrators to add and remove users to the system or modify the rights of the users. Single sign on improves security through the enhanced ability of system administrators to maintain the integrity of the user account configuration including the ability to inhibit or remove an individual user from having access to all system resources in a coordinated and consistent manner.

If the authentication system 135 of the portal 105 and portlets 110 are a federated authentication system, for example, ADFS, and the authentication system of the tenant 120 is a compatible federated authentication system, for example, ADFS, then authentication at the portal can be performed by using tokens 150 provided by the authentication system 130.

In, for example, ADFS, the tokens 150 are gathered from the authentication system 130 by the authentication system 135 without the need for the user 125 to provide additional user names or passwords. The authentication system 130 will only provide the tokens if the user 125 has previously authenticated with the authentication system 130. For example, a federated, claims based architecture based on an ADFS system with the authentication system 135 acting as a federate Security Token Service (STS) and authentication system 130 acting as a federated Identity Provider would enable single sign on. However, in general, the authentication systems 130 and 135 are not compatible, and, thus, it is difficult to implement a single sign on.

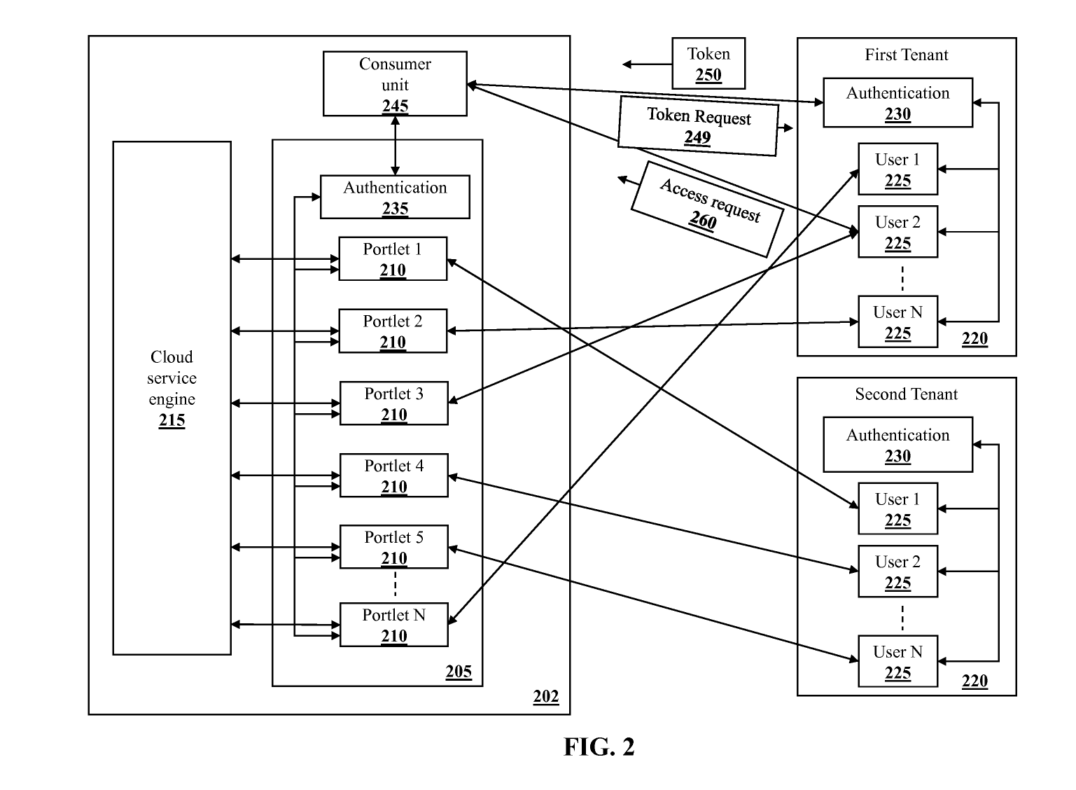

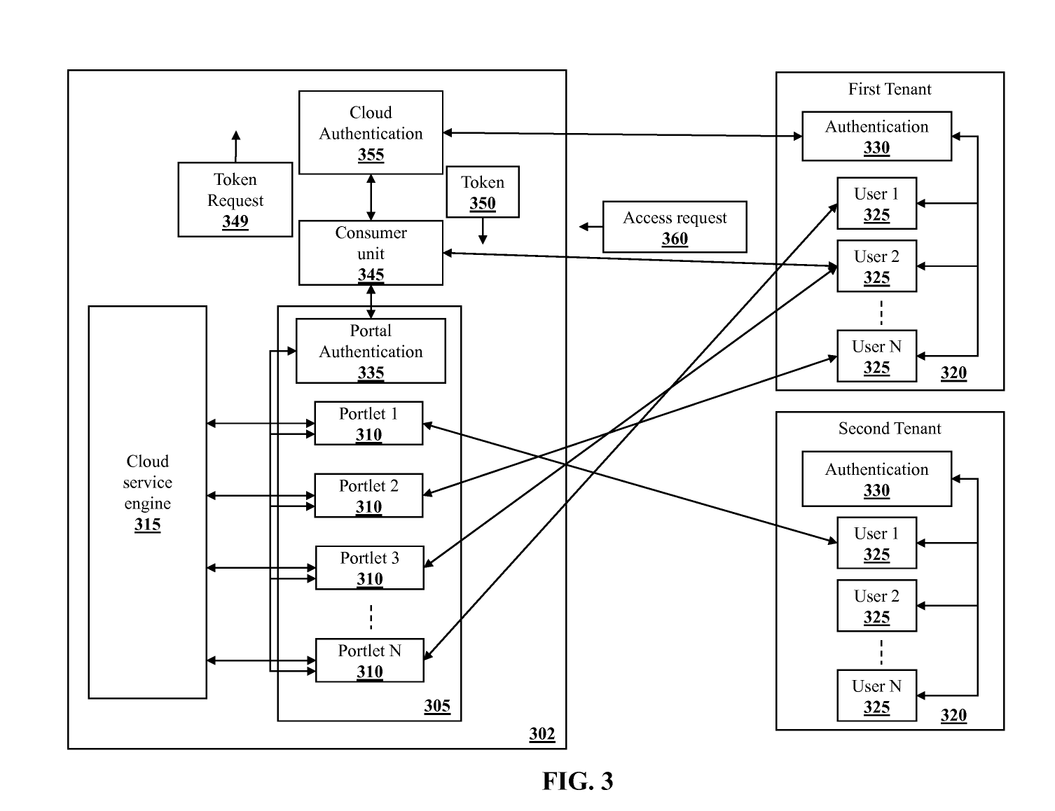

FIGS. 2 and 3 illustrate cloud systems 200 and 300 that overcome the compatibility issues of the authentication systems 130 and 135. Both systems 200, 300 include a consumer unit 245, 345 that provides an interface between different authentication systems. In the system 200, the consumer communicates directly with an authentication system of tenants 220. In the system 300, the consumer communicates with a cloud authentication system 355 within the cloud that is compatible with and federated to an authentication system of the tenants 320. Both the systems 200 and 300 provide single-sign-on for the users 225, 325 of the tenants 220, 320 using federated identity management.

The cloud system 200 comprises cloud service provider 202 and first and second tenants 220 that subscribe to the cloud service. The cloud service provider 202 comprises a cloud portal 205 that further comprises many portlets 210, a cloud service engine 215 that provides cloud services, and an authentication system 235. The tenants comprise users 225 that use the cloud, and an authentication system 230.

The cloud system 200 further comprises the consumer unit 245. The consumer unit 245 forms a mediator between the authentication system 230 and the authentication system 235. A user 225 needing to use the cloud service engine 215 contacts the consumer unit 245. The consumer unit 245 in turn contacts the authentication system 235 of the portal 205.

To use the tenant services, including gaining access to the cloud services, a user 225 authenticates with the authentication system 230 of the tenant. The user 225 may provide a user name and password, provide biometric data, or use any other means compatible with embodiments of the disclosure to authenticate with the authentication system 230. When the user 225 is authenticated with the authentication system 230, the user 225 contacts the consumer unit 245 with an access request 260 for a cloud service. The consumer unit 245 contacts the authentication system 235 of the portal 205 and requests access to one of the portlets 210. The authentication system 235, responds by requesting a specific form of token for the user 225. The consumer unit 245 identifies the tenant to which the user 225 belongs, and contacts the authentication system 230 of that tenant. The consumer unit 245 issues a token request 249 to request the specific form of token 250 from the authentication system 230. The authentication system 230 checks that the user is authenticated for the services of the corresponding tenant. If the user 225 is authenticated, the authentication system 230 completes and signs the token 250 and sends the token back to the consumer unit 245. The consumer unit 245 forwards the completed and signed token to the authentication system 235. The authentication system 235 provides access to the portlets 210 for the user 225 to access the cloud service engine 215. Thus, by using the system of FIG. 2, the user 225 only needs to authenticate with the corresponding authentication system 230 before using the cloud service engine 215.

Before the system 200 can be accessed by the users 225, a trust structure has to be established between the authentication system 230, the authentication system 235, and the consumer unit 245. In some embodiments, the trust can be established using predefined secure communications such as a Transport Layer Security (TLS), a Secure Sockets Layer (SSL), or a virtual private network (VPN). Trust can be established by using various cryptographic means to sign the tokens that are passed from the authentication system 230 to the authentication system 235. For example, a decryption key may be required by the authentication system 230 to validate signatures on the signed tokens. The authentication system 230 may store the keys in a key store. The authentication system 230 may also encrypt the token requests, and provide a public key so that only the authentication system 235 is capable of signing the requested token 250.

Trust can be established by the authentication system 235 by requesting specific information known to the authentication system 230, for example, a user name, a code issued to the user, a title for the user etc. Each specific piece of information is a claim in the claim based authentication system. The above claim information is provided to the authentication system 235 before the user 225 attempts to use the cloud service engine 215, so that the authentication system 235 can verify the claim.

In the above embodiment, the authentication system 230 acts as an identity provider. Identity providers are adapted to validate various user credentials, such as user names and passwords, and certificates, and are adapted to issue tokens.

In some embodiments, the authentication system 230 is, for example, an ADFS component provided by Microsoft Corporation, a Shibboleth® identity provider provided by the Internet2™ advanced networking consortium, or any other service adapted to act as an Identity provider.

The authentication system 235 has to request the tokens and verify the tokens when the tokens are received. In some embodiments, the authentication system 235 is, for example, an ADFS component, a Shibboleth® service provider, or any other service adapted to act as a requester and verifier of tokens.

In some embodiments, the portal is a Liferay™ Portal. Liferay™ is a free and open source enterprise portal written in Java and distributed under the GNU Lesser General Public License. In some embodiments, the Liferay™ Portal is adapted to provide the authentication system 235 and request and verify the tokens.

The consumer unit 245 is adapted to communicate with the authentication system 230 using a first security protocol, for example, the protocols for Shibboleth®, an ADFS component, or any other protocol compatible with embodiments of the disclosure. The consumer 245 is also adapted to communicate with the authentication system 235 using a second security protocol for example, the protocols for Shibboleth®, an ADFS component, or any other protocol compatible with embodiments of the disclosure. In some embodiments, the consumer unit 245 translates the token requests by the authentication system 235 from the protocol of the authentication system 235 to the protocol of the authentication system 230, and translates the tokens from the authentication system 230 from the protocol of the authentication system 230 to the protocol of the authentication system 235 if the protocols are different. In some embodiments, the consumer unit 245 automatically detects the types of the authentication systems 230, 235, and, therefore, the protocols used so that the protocol translation can be performed when forwarding token requests and tokens. Thus, the authentication system 230 and the authentication system 235 can use different protocols.

In some embodiments, the user 225 accesses the consumer 245 using a web browser and internet protocol. For example, the user 225 enters a web address corresponding to the internet address of the consumer 245 into the web browser. Alternatively, the user clicks on an internet link corresponding to the consumer 245 by using the web browser. In some embodiments, in response to the request by the user 225 the consumer 245 provides a web page to the user indicating that authentication is in progress. In some embodiments, the consumer 245 does not provide a response to the request by the user 225 until authentication is complete.

The cloud system 300 comprises cloud service provider 302 and first and second tenants 320 that subscribe to the cloud service. The cloud service provider 302 comprises a cloud portal 305 that further comprises many portlets 310, a cloud service engine 315 that provides cloud services, and an authentication system 335. The tenants comprise users 325 that use the cloud and an authentication system 330.

The cloud system 300 is similar to the cloud system 200 but further comprises a cloud authentication system 355. The consumer unit 345 forms a mediator between the cloud authentication system 355 and the authentication system 335. A user 325 needing to use the cloud service engine 315 contacts the consumer unit 345 with an access request 360. The consumer unit 345 contacts the authentication system 330 for access to the cloud service requested by the user 325. If a security token is required for the user 325 to access the cloud service engine 315, the authentication system 330 sends a token request 349 to the consumer unit 345. The consumer unit 345 contacts the authentication system 355 for access to the cloud services provided by cloud service engine 315. The authentication system 355 in-turn contacts the appropriate authentication system 330 of the tenants. The authentication system 355 is selected to use the same protocols as the authentication system 330. Therefore, there is no compatibility issue between the authentication system 330 and the authentication system 355

To use the tenant services, including gaining access to the cloud services, the user 325 authenticates with the authentication system 330 at the tenant. The user 325 may provide a user name and password, provide biometric data, or use any other means compatible with embodiments of the disclosure to authenticate with the authentication system 330. When the user 325 is authenticated with the authentication system 330, the user 325 contacts the consumer unit 345. The consumer unit 345 contacts the authentication system 335 of the portal 305 and requests access to the portlets 310. The authentication system 335, responds by requesting a specific form of token for the user 325. The consumer unit 345, contacts the authentication system 355 of the cloud provider. The consumer unit 345 requests the specific form of token from the authentication system 355. The authentication system 355 identifies the tenant 320 for the user 325 and contacts the respective authentication system 330 to request a token 350 for the user 325, based on the token 350 requested by the consumer unit 345. The authentication system 330 checks to see that the user is authenticated for the services of the corresponding tenant 320. If the user 325 is authenticated, the authentication system 330 completes and signs the token and sends the token 350 back to the authentication system 355. The authentication system 355 completes the token requested by the consumer unit 345 based on the token issued by the authentication system 330 and issues the token 350 to the consumer unit 345. The consumer unit 345 forwards the completed and signed token 350 to the authentication system 335. The authentication system 335 provides access to the portlets 310 for the user 325 to access the cloud service engine 315. Thus, by using the system of FIG. 3, the user 325 only needs to authenticate with the corresponding authentication system 330 before using the cloud service engine 315.

Before the system 300 can be accessed by the users 325, a trust structure has to be established between the authentication system 330, the authentication system 335, authentication system 355, and the consumer unit 345. In some embodiments, the trust can be established using predefined secure communications such as a Transport Layer Security (TLS), a Secure Sockets Layer (SSL), or a virtual private network (VPN). In some embodiments, the trust can be established by using various cryptographic means to sign the tokens 350 that are passed from the authentication system 330 to the authentication system 335, and the tokens 350 passed from the authentication system 335 to the authentication system 335. For example, decryption keys may be required to validate signatures on the issued tokens. The authentication system 330 may store the keys in a key store. The authentication system 330 may also encrypt the token requests, and provide a public key so that only the authentication system 355 and/or the authentication system 335 is capable of signing the requested token.

The consumer unit 345 is adapted to communicate with the authentication system 330 using a first security protocol, for example, the protocols for Shibboleth®, an ADFS component, or any other protocol compatible with embodiments of the disclosure. The consumer 345 is also adapted to communicate with the authentication system 355 using a second security protocol for example, the protocols for Shibboleth®, an ADFS component, or any other protocol compatible with embodiments of the disclosure. In some embodiments, the consumer unit 345 translates the token requests by the authentication system 335 from the protocol of the authentication system 335 to the protocol of the authentication system 355 and translates the tokens from the authentication system 355 from the protocol of the authentication system 355 to the protocol of the authentication system 335 if the protocols are different. In some embodiments, the consumer unit 345 automatically detects the types of the authentication systems 335, 355 and, therefore, the protocols used so that the protocol translation can be performed when forwarding token requests and tokens. Thus, the authentication system 335 and the authentication system 355 can use different protocols.

In some embodiments, the user 325 accesses the consumer 345 using a web browser and internet protocol. For example, the user 325 enters a web address corresponding to the internet address of the consumer 345 into the web browser. Alternatively, the user clicks on an internet link corresponding to the consumer 345 using the web browser. In some embodiments, in response to the request by the user 325 the consumer 345 provides a web page to the user indicating that authentication is in progress. In some embodiments, the consumer 345 does not provide a response to the request by the user 325 until authentication is complete.

In some embodiments, the consumer units 245, 345 can be implemented, for example, using the Java based WS-trust protocol and the Web service Interoperability technologies (WSIT). In one embodiment, a WSIT implementation of metro web services is used. WSIT is an open-source project for the next-generation of Web service technologies. WSIT provides interoperability between Java Web Services and Microsoft's Windows Communication Foundation. WSIT consists of Java programming language APIs that enable advanced WS-* features to be used in a way that is compatible with, for example, Microsoft's Windows Communication Foundation (WCF) as used by Microsoft .NET®. The interoperability between different products is accomplished by implementing a number of Web Services specifications, like JAX-WS that provides interoperability between Java Web Services and Microsoft Windows Communication Foundation. WSIT implements the following WS-* protocols

WS-MetadataExchange

WS-Transfer

WS-Policy

WS-Security

WS-SecureConversation

WS-Trust

WS-SecurityPolicy

WS-ReliableMessaging

WS-RMPolicy

WS-Coordination

WS-AtomicTransaction

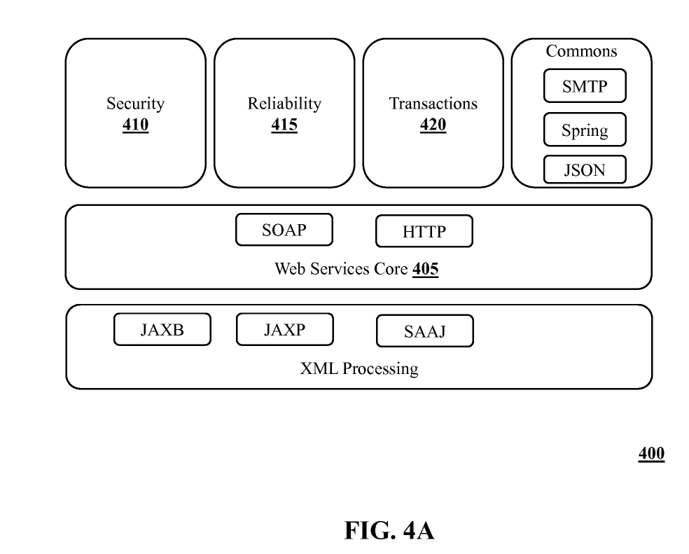

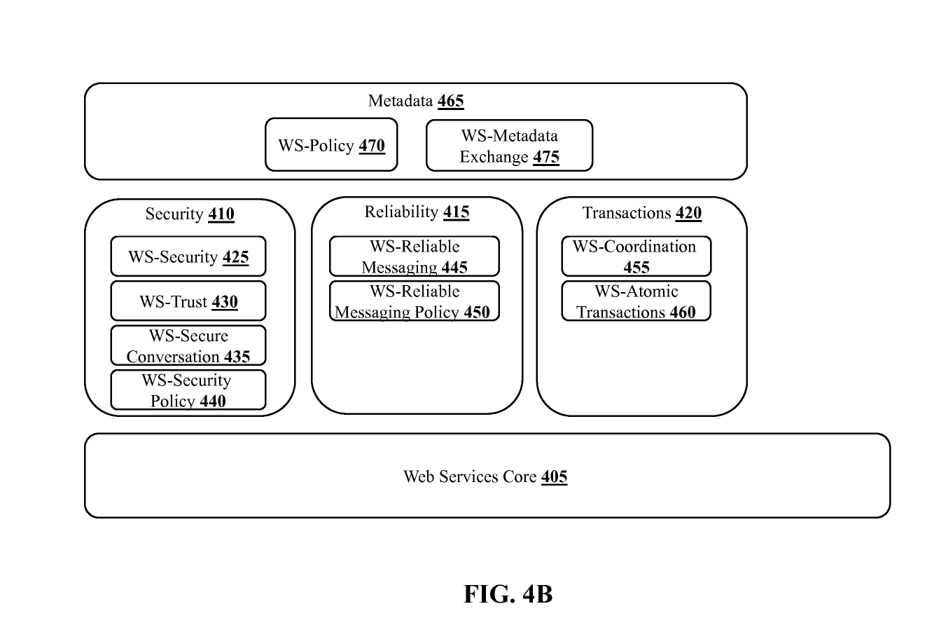

FIG. 4A illustrates WS-Trust, WS-Policy that are used. The major components are the JAX-WS RI—the core Web services platform 405 and an implementation of Reliability 415, Security 410, and Transactions 420 for WS-* specifications and interoperability with .NET 3.0/3.5

The Java API for XML Web Services JAX-WS RI provides the Core Web services platform 405. This includes all the SOAP message functionality, including WS-Addressing and MTOM. The JAX-WS RI is an implementation of the JAX-WS specification.

WSIT implements support for Security 410, Reliability 415, and Transactions 420, using the protocols and mechanisms defined by several WS-* specifications, on this Core layer 405. This allows a Java client to communicate with a Java endpoint using these protocols. In addition these protocols also enable interoperability with the Windows Communication Foundation component of .NET 3.0/3.5 frameworks, and therefore, provide access to the ADFS APIs.

FIG. 4B illustrates the different WS-* specifications implemented in the areas of Security 410, Reliability 415, and Transactions 420.

In Security 410, WS-Security 425 provides a basic framework for SOAP message level security in Web services. WS-Trust 430 defines a framework for issuing, renewing, and validating security tokens, and brokering trust relationships within different trust domains. WS-Secure Conversation 435 increases the overall performance and security by defining semantics for secure message exchange for multiple message exchanges. WS-Security Policy 440 enables Web service endpoints to specify their security requirements to potential clients in an interoperable manner.

In Reliability, WS-Reliable Messaging 445 defines a messaging protocol to identify, track, and manage the reliable message delivery between two parties, a source and a destination. WS-Reliable Messaging Policy 450 enables a Web service endpoint to indicate that a reliable message delivery is required.

In Transactions, WS-Coordination 455 provides an extensible framework for defining coordination context and types for protocols that coordinate distributed actions. WS-Atomic Transactions 460 provides the definition of transaction context and atomic transaction coordination type that is to be used with the framework defined by WS-Coordination. This enables transactions flowing over Web services.

Metadata section 465 identifies the mechanisms that allow the Security, Reliability, and Transactional capabilities of an endpoint to be published and consumed by a client in an interoperable manner. WSPolicy 470 defines a general-purpose framework to express the capabilities of an endpoint.

The above extensible framework is then used to define the domain-specific policy assertions. WS-Metadata Exchange and WS-Transfer are used by the client to retrieve the information about the endpoint.

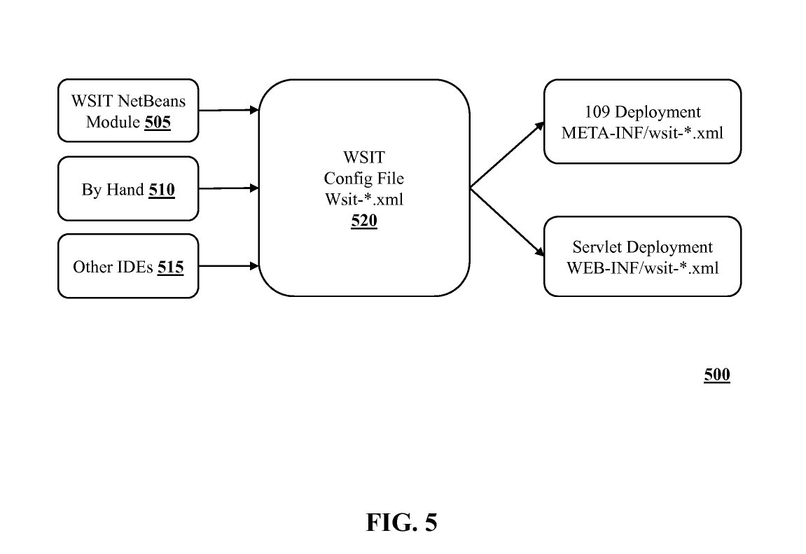

FIG. 5: illustrates the programming model with WSIT. The programming model leverages the existing JAX-WS and EJB programming models and allows us to define Security, Reliability, and Transactional capability on the endpoints by bundling an additional configuration file with the application.

The configuration file can be easily generated using the NetBeans integrated development environment 505 or can be written by hand 510, or using any other integrated development environment 510 that has inbuilt WSIT or with WSIT plug-in added. On the client side, an optional WSIT configuration file 520 may be used to specify certain client-side parameters such the locations of trust and keystores.

Most Servlet Containers that can be used with Liferay™ including Apache Tomcat™, Glassfish™ are supported by metro web services. Thus, if the portal 205, 305 is implemented using Liferay™, the portal can communicate with the consumer 245, 345 using metro web services and with ADFS authentication systems using WIST.

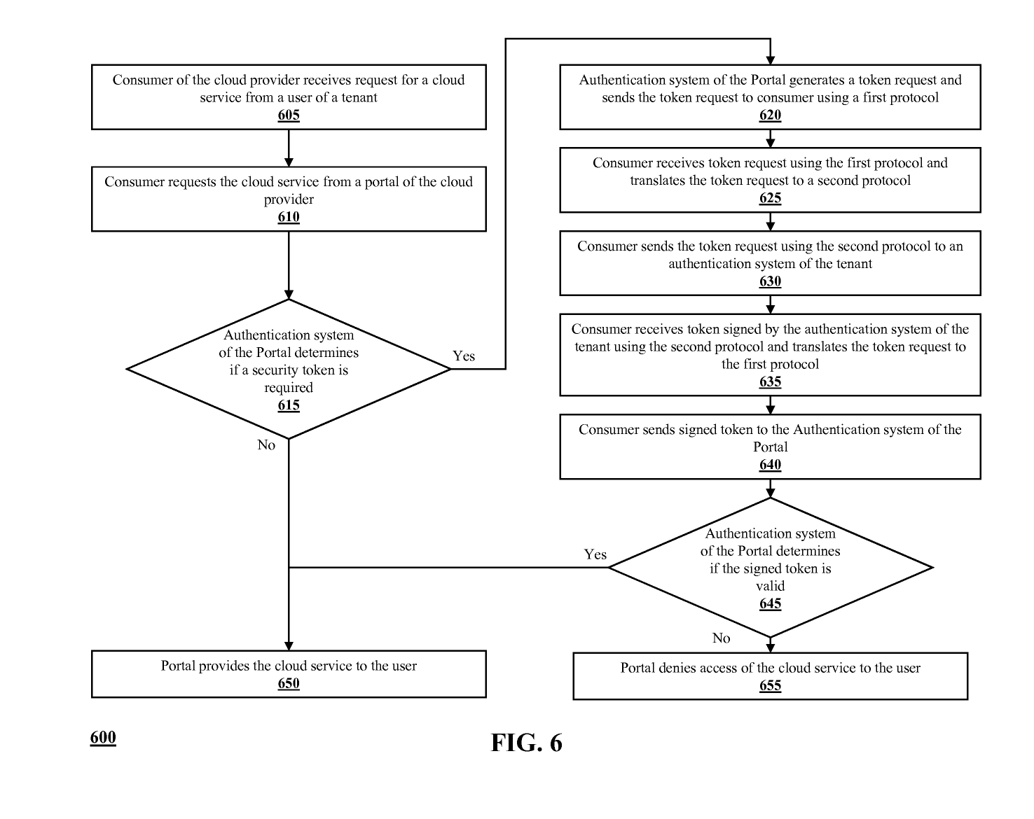

FIG. 6 illustrates a method 600 for single sign on to a cloud provider. The method begins at step 605. At step 605, the consumer of the cloud provider receives a request for a cloud service from an user of a tenant. The consumer may be, for example, consumer unit 245 or 345. The consumer may be a web page portal, and the request may be in the form of a web page request. When the request has been received the method proceeds to step 610.

At step 610, the consumer requests the cloud service from a portal of the cloud provider, for example, portal 205, 305. When the request has been sent the method proceeds to step 615.

At step 615, the authentication system of the portal, for example, authentication system 235, 335 determines if a security token is required. If a security token is required, the method proceeds to step 620. If a security token is not required, the method proceeds to step 650.

At step 620, the authentication system of the portal generates a token request and sends the token request to consumer using a first protocol. The first protocol may be, for example, the Java WSIT based protocol as discussed above or protocols for ADFS. The token request contains a list of the information that the authentication system of the portal expects to see in the returned signed token. The token request may be generated from a policy file. When the request has been sent, the method proceeds to step 625

At step 625, the consumer receives the token request using the first protocol and translates the token request to a second protocol. The second protocol is the protocol expected by the authentication system of the tenant. The second protocol may be, for example, the Java WSIT based protocol as discussed above or protocols for ADFS. The information contained in the token request in the second protocol is the same as the information contained in the request in the first protocol. When the translation is complete, the method proceeds to step 630.

At step 630, the consumer sends the token request using the second protocol to an authentication system of the tenant of the user. The authentication system of the tenant of the user performs steps 715-725, as discussed below. When the token request has been sent, the method proceeds to step 635.

In some embodiments, for example, the cloud system 300 the consumer does not send the token request to an authentication system of the tenant of the user. The consumer sends the token request to an authentication system of the cloud service provider, for example, authentication system 355 that is federated with the authentication system of the tenant of the user. The authentication system of the cloud service provider signs the token based on communication with the authentication system of the tenant of the user. The authentication system of the cloud service provider then returns the signed token to the consumer and the method proceeds to step 635.

At step 635, the consumer receives the token signed by the authentication system of the tenant using the second protocol and translates the token request to the first protocol. When the translation of the token is complete, the method proceeds to step 640. At step 640, the consumer sends the signed token to the authentication system of the Portal using the first protocol. When the signed token has been sent, the method proceeds to step 645. At step 645, the authentication system of the Portal determines if the signed token is valid. If the signed token is valid, the method proceeds to step 650. If the token is not valid, the method proceeds to step 655.

At step 650, the portal provides the cloud service to the user and the method terminates. At step 655, the portal denies access of the cloud service to the user and the method terminates.

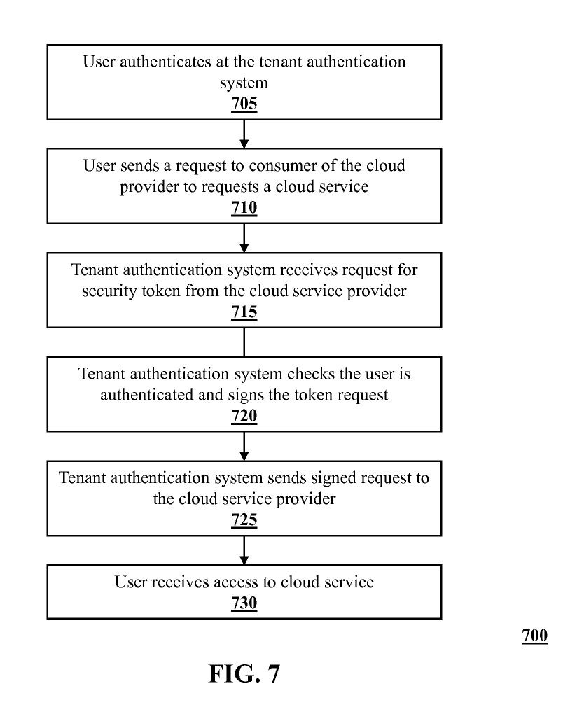

FIG. 7 illustrates a method 700 for single sign on to a cloud provider. The method begins at step 705. At step 705, the user authenticates at the tenant authentication system. When the authentication is complete, the method proceeds to step 710.

At step 710, the user sends request to the consumer of the cloud provider to request a cloud service. When the request has been sent, the method proceeds to step 715.

At step 715, the tenant authentication system receives a request for a security token from the cloud service provider. When the request for the security token has been received, the method proceeds to step 720.

At step 720, the tenant authentication system checks that the user is authenticated, and signs the token request. When the request for the security token has been signed, the method proceeds to step 725.

At step 725, the tenant authentication system sends the signed request to cloud service authentication system. When the signed security token has been sent, the method proceeds to step 730. At step 730, the user receives access to the cloud service from the cloud provider.

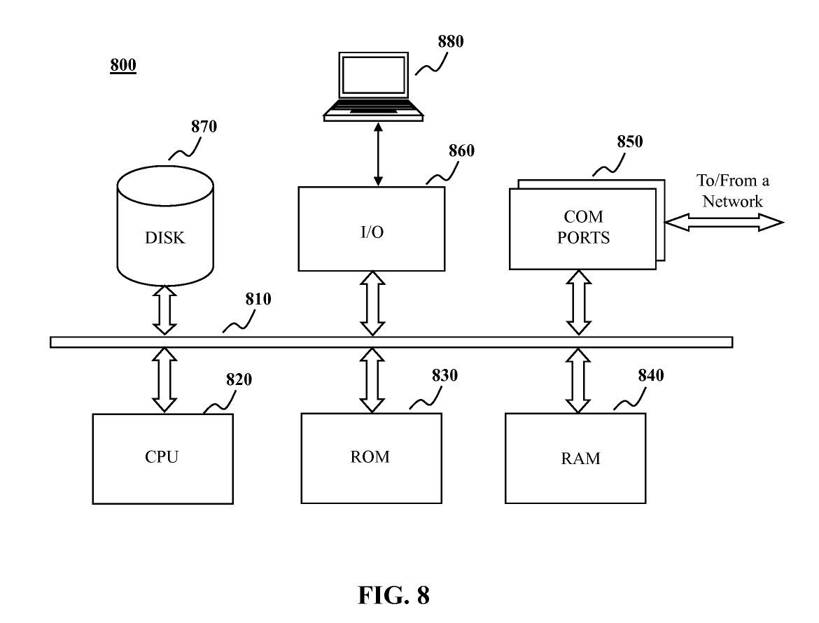

FIG. 8 depicts a general computer architecture on which the present embodiments can be implemented and has a functional block diagram illustration of a computer hardware platform that includes user interface elements. The computer may be a general purpose computer or a special purpose computer. The computer 800 can be used to implement any components of the systems 100, 200 and 300. For example, authentication systems 130, 135, 230, 235, 330, 335 the consumer units 245, 335, can all be implemented on a computer such as computer 800, by using the hardware, software program, firmware, or a combination of these components of the computer 800. Although only one computer 800 is shown, for convenience, the computer functions relating to single sign on may be implemented in a distributed fashion on a number of similar platforms, to distribute the processing load.

The computer 800, for example, includes COM ports 850 connected to and from a network to facilitate data communications. The computer 800 also includes a central processing unit (CPU) 820, in the form of one or more processors, for executing program instructions. The exemplary computer platform includes an internal communication bus 810, program storage and data storage of different forms, for example, disk 870, read only memory (ROM) 830, or random access memory (RAM) 840, for various data files to be processed and/or communicated by the computer, as well as possibly program instructions to be executed by the CPU. The computer 800 also includes an I/O component 860, supporting input/output flows between the computer and other components such as user interface elements 880. The computer 800 may also receive programming and data via network communications.

Hence, aspects of the methods and systems for single sign on according to an embodiment, as discussed above, may be embodied in program elements. Program aspects of the embodiments may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the program elements.

All or portions of the program elements may at times be communicated through a network such as the Internet or various other telecommunication networks. Such communications, for example, may enable loading of the software from one computer or processor into another, for example, from a management server or host computer into the hardware platform(s) of a computing environment or other system. Other types of media that may carry the program elements include optical, electrical and electromagnetic waves, such as used across physical interfaces between local devices, through wired, and optical networks and over various wireless links. The physical elements that carry such waves, such as wired or wireless links, optical links, or the like, also may be considered as media carrying the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium, or physical transmission medium. Non-volatile storage media include, for example, optical or magnetic disks, such as any of the storage devices in any computer(s) or the like, which may be used to implement the single sign on system or any of the components of the single sign on systems as shown in the drawings. Volatile storage media include dynamic memory, such as a main memory of such a computer platform. Tangible transmission media include coaxial cables, copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media, therefore, include, for example, a floppy disk, a flexible disk, hard disk, solid state disk magnetic tape, any other magnetic medium, a CD-ROM, DVD, Blue-Ray™ or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The embodiments described above are intended to be exemplary. One skilled in the art recognizes that numerous alternative components and embodiments that may be substituted for the particular examples described herein and still fall within the scope of the invention.

What is claimed is:

1. A system for single sign on to a cloud, the system comprising:
a cloud service provider comprising:
a consumer unit that provides an interface for a user to connect to the cloud service provider; and
a portal that provides a cloud service to the user, the portal comprising a first authentication system that issues a security token request, and the first authentication system is connected to the consumer unit; and
a tenant comprising:
the user; and
a second authentication system that signs the security token request, wherein
the consumer unit is adapted to communicate with the first authentication system using a first protocol and adapted to communicate with the second authentication system using a second protocol.

2. The system according to claim 1, wherein the consumer unit is adapted to request the cloud service from the portal based on a request for the cloud service from the user.

3. The system according to claim 1, wherein
the consumer unit is adapted to translate a security token request in the first protocol to a security token request in the second protocol; and
the consumer unit is adapted to translate a signed security token in the second protocol to a signed security token in the first protocol.

4. The system according to claim 3, wherein
the consumer unit is adapted to receive the security token request in the first protocol from the first authentication system based on a request for the cloud service from the user; and
the consumer unit is adapted to send the security token request in the second protocol to the second authentication system.

5. The system according to claim 1, the portal comprising a plurality of portlets, and the portal adapted to assign the user to a one of the plurality of portlets to provide the cloud service.

6. The system according to claim 1, wherein the second authentication system is adapted to authenticate the user.

7. A system for single sign on to a cloud, the system comprising:
a cloud service provider comprising:
a consumer unit that provides an interface for a user to connect to the cloud service provider;
a portal that provides a cloud service to the user, the portal comprising a first authentication system connected to the consumer unit; and
a second authentication system connected to the consumer unit; and
a tenant comprising:
the user; and
a third authentication system connected to the user,
wherein the consumer unit is adapted to communicate with the first authentication system using a first protocol and adapted to communicate with the second authentication system using a second protocol; and
wherein the second authentication system is federated with the third authentication system.

8. The system according to claim 7, wherein the consumer unit is adapted to request the cloud service from the portal based on a request for the cloud service from the user.

9. The system according to claim 7, wherein
the consumer unit is adapted to translate a security token request in the first protocol to a security token request in the second protocol; and
the consumer unit is adapted to translate a signed security token in the second protocol to a signed security token in the first protocol.

10. The system according to claim 9, wherein
the consumer unit is adapted to receive the security token request in the first protocol from the first authentication system based on a request for the cloud service from the user; and
the consumer unit is adapted to send the security token request in the second protocol to the second authentication system.

11. The system according to claim 7, the portal comprising a plurality of portlets, and the portal adapted to assign the user to a one of the portlets to provide the cloud service.

12. The system according to claim 7, wherein the third authentication system is adapted to authenticate the user.

13. A method for single sign on to a cloud system, the method comprising:
receiving, by a consumer unit of a cloud provider, a request from a user for a cloud service;
requesting, by the consumer unit, a portal to provide access to the cloud service based on the request from the user;
requesting, by a first authentication system of the portal, a security token from the consumer unit using a first protocol, the request by the first authentication system based on the request by the consumer unit;
translating, by the consumer unit, the security token request from the first protocol to a second protocol;
requesting, by the consumer unit, a second authentication system to sign the requested security token using the second protocol;
receiving, by the consumer unit, the signed security token;
translating, by the consumer unit, the signed security token from the second protocol to the first protocol;
sending, by the consumer unit, the signed security token to the portal using the first protocol; and
providing, by the portal, the cloud service to the user based on the signed security token.

14. The method of claim 13, wherein the second authentication system is an authentication system of a tenant of the user that authenticated the user.

15. The method of claim 13, wherein the second authentication system is an authentication system of the cloud provider and the second authentication system is federated with an authentication system of a tenant of the user that authenticated the user.

16. The method of claim 13, wherein if the signed security token is not valid then the user is denied access to the cloud service.

17. A machine-readable tangible and non-transitory medium with information recorded thereon, wherein the information, when read by a machine, causes the machine to perform the following steps:
receive, by a consumer unit of a cloud provider, a request from a user for a cloud service;
request, by the consumer unit of the cloud provider, a portal to provide access to the cloud service based on the request by the user;
request, by a first authentication system of the portal, a security token from the consumer unit using a first protocol based on the request from the consumer unit;
translate, by the consumer unit, the security token request from the first protocol to a second protocol;
request, by the consumer unit, a second authentication system to sign the requested security token using the second protocol;
translate, by the consumer unit, the signed security token from the second protocol to the first protocol;
send, by the consumer unit, the signed security token to the portal using the first protocol; and
provide, by the portal, the cloud service to the user based on the signed security token.

18. The machine-readable medium of claim 17, wherein the second authentication system is an authentication system of a tenant of the user that authenticated the user.

19. The machine-readable medium of claim 17, wherein the second authentication system is an authentication system of the cloud provider and the second authentication system is federated with an authentication system of a tenant of the user that authenticated the user.

20. The machine-readable medium of claim 17, wherein if the signed security token is not valid then the user is denied access to the cloud service.
